(19) United States
(12) Patent Application Publication
(10) Pub. No.: US 2014/0089144 A1
(43) Pub. Date: Mar. 27, 2014

(54) APPARATUS, SYSTEM, METHOD AND COMPUTER-ACCESSIBLE MEDIUM FOR PERFORMING A PRODUCT SEARCH USING USER-GENERATED AND CROWD-SOURCED CONTENT

(71) Applicants: Beibei Li, Pittsburgh, PA (US); Anindya Ggose, New York, NY (US); Panagiotis G, Ipeirotis, New York, NY (US)

(72) Inventors: Beibei Li, Pittsburgh, PA (US); Anindya Ggose, New York, NY (US); Panagiotis G, Ipeirotis, New York, NY (US)

(73) Assignee: New York University, New York, NY (US)

(21) Appl. No.: 13/884,198

(22) PCT Filed: Nov. 7, 2011
(86) PCT No.: PCT/US11/59609

§ 371 Date: Nov. 25, 2013

Related U.S. Application Data
(60) Provisional application No. 61/411,419, filed on Nov. 8, 2010.

(51) Int. Cl. G06Q 30/06

(52) U.S. Cl. CPC G06Q 30/0625
USPC 705/26.62

(57) ABSTRACT

A non-transitory computer-readable medium, method and system for providing results associated with a ranking of a plurality of items of a particular item type can be provided. For example, for each respective item of a plurality of items having an associated cost, it is possible to (i) determining an item utility value for the respective item of the items based on aggregate data associated with a plurality of users without requiring utilization of information particular to each of the users, and (ii) determine a surplus value for the respective item as the item utility value less a cost utility value associated with the cost of the respective item. Further, it is possible to provide the results, based on the respective surplus values, to a particular user of the users.

### CROSS-REFERENCE TO RELATED APPLICATIONS

This application claims priority to U.S. Provisional Application Ser. No. 61/411,419, filed on Nov. 8, 2010, the disclosure of which is incorporated by reference herein in its entirety.

### FIELD OF THE DISCLOSURE

Exemplary embodiments of the present disclosure relate to a performance of a product search using user-generated and crowd-sourced content, and in particular to a utility and surplus based ranking system, apparatus, method, and computer-readable medium that can be used to calculate the utility of product/service choices, calculate a surplus as the utility of the product less the utility of the money associated with the cost, to provide, e.g., a “best value for money” ranking of comparable items. Further, the exemplary embodiments of the system, apparatus, method, and computer-readable medium of the present disclosure can construct these rankings without customer specific data, or provide tailored results with minimal customer specific data.

### BACKGROUND INFORMATION

Online searches for products are increasing in popularity, as more and more users search and purchase products from the Internet. Traditional search engines for products are based on models of relevance from “classic” information retrieval theory or use variants of faceted search to facilitate browsing. However, the decision mechanism that underlies the process of buying a product is different from the process of finding a relevant document or object. Customers do not simply seek to find something relevant to their search, but also try to identify the “best” deal that satisfies their specific desired criteria. Traditional product search engines provide only rudimentary ranking facilities for search results, typically using a single ranking criterion such as name, price, best selling (volume of sales), or more recently, using customer review ratings. This approach has some shortcomings. First, such approach ignores the multidimensional preferences of consumers. Second, it fails to leverage the information generated by the online communities, going beyond simple numerical ratings. Third, this approach insufficiently accounts for the heterogeneity of consumers.

Recommender systems can be used to fix and/or address some of these problems, although existing techniques have certain limitations. For example, many of the recommendation mechanisms require consumers to log into the system. However, in reality, many consumers browse only anonymously. Due to the lack of any meaningful, personalized recommendations, consumers do not feel compelled to login before purchasing. For example, on Travelocity®, it is believed that less than 2% of the users actually login. However, even when such user do login, before or after a purchase, such users/customers are reluctant to give their individual demographic information due to a variety of reasons (e.g., time constraints, privacy issues, etc.). Therefore, most context information is missing at the individual consumer level.

Additionally, for goods with a low purchase frequency for an individual consumer, such as, e.g., hotels, cars, real estate, or even electronics, there are few repeated purchases that could be leveraged towards building a predictive model (i.e., models based on collaborative filtering). Also, as privacy issues become increasingly important, marketers may not have access to the individual-level purchase history of each consumer (or consumer segment). In contrast, aggregate purchase statistics (e.g., market share) can be easier to obtain, but various procedures that rely on knowing individual level behavior lack the ability of deriving consumer preferences from such aggregate data.

Some alternative techniques attempt to identify the “Pareto optimal” set of results. However, the feasibility of such approaches can diminish as the number of product characteristics increases. With more than five or six characteristics, the probability of a point being classified as “Pareto optimal” can dramatically increase. As a consequence, the set of Pareto optimal results can include every product.

These drawbacks illustrate a need for a recommendation strategy for products that can better model consumers' underlying behavior, to capture their multidimensional preferences and heterogeneous tastes.

### SUMMARY OF EXEMPLARY EMBODIMENTS

Thus, to address at least such needs, certain exemplary embodiments of exemplary architectures, systems, apparatus, methods, and computer-readable medium can be provided for a utility and surplus based product and/or service searching platform.

For example, the exemplary embodiment can include a system for executing, a method of executing, or a computer-accessible medium to cause execution of an exemplary procedure for results associated with a ranking of a plurality of items of a particular item type. The exemplary procedure can, e.g., for each respective item of a plurality of items having an associated cost, (a) determine an item utility value for the respective item based on aggregate data associated with a plurality of users without requiring utilization of information particular to each of the users, and (b) determine a surplus value for the respective item as the item utility value less a cost utility value associated with the cost of the respective item. Further, the exemplary procedure can provide results, based on the respective surplus values, to a particular user.

According to the exemplary procedure, the providing results can include providing a list of products or services sorted or ranked based on the respective surplus values. In the exemplary procedure, the results can include particular products that represent the best value for a particular consumer or group of consumers and the particular products differ from a list of best selling products. In the exemplary procedure, each item can include a plurality of characteristics, each characteristic can have a particular value for the particular item, each characteristic can have a weight, and the determining an item utility value for a respective item can include summing weighted utility values for each characteristic of the respective item.

In the exemplary procedure, the weight for each characteristic can be determined based exclusively on anonymous data, and results are provided to the particular user without accounting for information specific to that particular user. The exemplary procedure can also receive some demographic data of the particular user, and modify the weight for a plurality of characteristic categories to reflect the particular user's demographic data. The exemplary procedure can also receive financial data of the particular user, and modify the cost utility value based on the financial data of the particular user. Further, in the exemplary procedure, the weights can be based on market share data. The exemplary procedure can also receive consumer demographic information for a plurality of consumers, receive demand data for the plurality of products and select particular products based on the consumer demographic information and demand data. In the exemplary embodiment, the selected particular products can include a personalized surplus-based ranking of the products. In the exemplary embodiment, the preferences of consumers for different product characteristics can be inferred from demand data for the plurality of products.

These and other objects, features and advantages of the exemplary embodiment of the present disclosure will become apparent upon reading the following detailed description of the exemplary embodiments of the present disclosure, when taken in conjunction with the appended claims.

### BRIEF DESCRIPTIONS OF THE DRAWINGS

Further objects, features and advantages of the present disclosure will become apparent from the following detailed description taken in conjunction with the accompanying Figures showing illustrative embodiments of the present disclosure, in which:

FIG. 1 is a logarithmic graph of the utility of money from economic theory according to certain exemplary embodiments of the present disclosure;

FIG. 2A is a flow diagram of a method or procedure according to certain exemplary embodiments of the present disclosure for providing an exemplary evaluation and ranking flow;

FIG. 2B is a flow diagram of an exemplary method for performing an exemplary procedure of the exemplary method of FIG. 2A;

FIG. 3 is another flow diagram of a method or procedure according to further exemplary embodiments of the present disclosure for providing the exemplary evaluation and ranking flow using user-specific context data; and

FIG. 4 is a schematic diagram of a system according to another exemplary embodiments of the present disclosure; and

FIG. 5 is another flow diagram of a method or procedure according to certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures. It is intended that changes and modifications can be made to the described exemplary embodiments without departing from the true scope and spirit of the subject disclosure as defined by the appended claims.

### DETAILED DESCRIPTION OF EXEMPLARY EMBODIMENTS

According to certain example embodiments of the present disclosure, certain fundamental concepts from economics can be explored: utility and surplus. For example, utility can be defined as a measure of the relative satisfaction from, or desirability of, consumption of various goods and services. Each product can provide consumers with an overall utility, which can be represented as the aggregation of weighted utilities of individual product characteristics. At the same time, the action of purchasing trades off the utility of the money that is spent for buying the product. With the assumption that consumers are rational, the decision-making process behind purchasing can be viewed as a process of utility maximization that takes into consideration both product quality and price. Based on an exemplary utility theory, exemplary embodiments of the present disclosure include a new ranking system that uses demand-estimation approaches from economics to generate the weights that consumers implicitly assign to each individual product characteristic.

One characteristic of this exemplary approach can be that it does not require purchasing information for individual customers, but rather relies on aggregate demand data. Based on the estimated weights, according to the exemplary embodiment of the present disclosure, it is possible to then derive the surplus for each product, which can represent how much extra utility one can obtain by purchasing a product. Further, it is possible to rank some or all of the products according to their surplus. It is further possible to extend the ranking strategy to a personalized level, based on the distribution of consumers' demographics.

According to further exemplary embodiments of the present disclosure, an exemplary implementation of a hotel search engine can be utilized, although any product, service, or mix of products and/or services can be ranked using the exemplary features of these exemplary embodiments. In one exemplary implementation, a hotel search engine was utilized for, e.g., more than 15,000 user evaluations, demonstrating an overwhelming preference for the ranking generated by systems, apparatus, method and computer-readable medium according to the exemplary embodiments of the present disclosure, compared to a large number of existing baselines.

Using such exemplary systems, apparatus, method and computer-readable medium according to exemplary embodiments of the present disclosure, it is possible to make recommendations based on a better understanding of the underlying causality of consumers' purchase decisions. An exemplary user model can be utilized that captures the decision-making process of consumers, leading to a better understanding of consumer preferences. This can be in contrast to building a “black-box” style predictive model using machine learning algorithms. The exemplary causal model can relax the assumption of a consistent environment across training and testing data sets, can allow for changes in the modeling environment, and can predict what should occur even when things change.

Exemplary systems, apparatus, method and computer-readable medium according to certain exemplary embodiments of the present disclosure can infer personal preferences from aggregate data, e.g., in a privacy-preserving manner that does not require individual accounts, information, or logins. An exemplary procedure can be used to learn consumer preferences based on the largely anonymous, publicly observed distributions of consumer demographics, as well as the observed aggregate-level purchases (e.g., anonymous purchases and market shares for relevant products, e.g., hotels in NYC and LA), and not necessarily by learning from the identified behavior or demographics of each individual. According to a further exemplary embodiment of the present disclosure, a ranking method can be utilized which can use the notion of surplus, which is not only theory-driven (e.g., based on proven economic theories) but also generates systematically better results than traditional approaches (e.g., empirically proven superior results).

Exemplary systems, apparatus, method and computer-readable medium according to additional exemplary embodiments of the present disclosure can provide improved search results using the following theoretical economic bases: utility theory, characteristics-based theory, and surplus, to identify the best products for a consumer. For example, a user may be looking for a hotel in a particular market, e.g., New York City. This user might prefer a place of good quality, but preferably costing not more than a particular maximum rate, e.g., $300 per night. The exemplary user can conduct a faceted search (e.g., with respect to price and ratings). Traditionally, this could be as simple as filtering out options over $300, while ordering the results by some rating criteria (e.g., stars, user ratings, price, etc.). However, with the traditional explicit price constraint, the user may miss some “great deal” with much higher value, but a slightly higher price. For instance, an exemplary 5-star hotel (e.g., the Mandarin) might be running a promotion that week with a discounted price of, e.g., $333 per night. The Mandarin may offer the most luxurious environment and room services, and the price for the Mandarin could normally be around $900 per night. In this illustrative example, although the price is $33 above the budget, the user can be very likely to be willing and prefer to “grab the deal” if this hotel appeared in the search result.

Some traditional search filters can provide a result outside the user specified range, e.g., a user who specifies hotels under $300 may be given hotels within 10%, or $330 and under. However, such procedures can provide only additional results, based on a broader filter, including both “good” deals in the $300-330 range, and relatively “bad” deals in the $300-330 range. This possible filter expansion is wholly unrelated to characteristic based utility and surplus maximization, which maximizes “good deal” results, while minimizing “bad deal” results, based on product/service characteristics and aggregate and/or specific user-determined value weights versus trade-off costs, e.g., price.

Exemplary systems, apparatus, method and computer-readable medium according to further exemplary embodiments of the present disclosure can utilize such concept of surplus from economics to facilitate a search result inclusive of such deals. In this exemplary context, surplus can be, e.g., a measure of the benefits consumers derive from the exchange of goods, e.g., for money. Once the exemplary embodiment derives the surplus from each product, it can then rank the products according to their surplus and provide a ranking where a user can easily find the best product that provides the highest benefits to the user. In this regard, the exemplary systems, apparatus, method and/or computer-readable medium can be used to further quantify the gain from buying a product/service, by deriving the utility.

An exemplary Utility Maximization Surplus can be derived from utility and rational choice theories. Exemplary embodiments of the present disclosure can utilize the fundamental notion in utility theory in which each consumer is endowed with an associated utility function U, which is a measure of the satisfaction from consumption of various goods and services. The rationality assumption can define that each person tries to maximize its own utility. In the exemplary context of purchasing decisions, the exemplary embodiments can assume that the consumer has access to a set of products, each product having a particular price. Exemplary embodiments can analyze two components for the utility function: utility of each particular product versus the utility of money. Exemplary systems, apparatus, method and computer-readable medium can then assume that a consumer has a choice across n products, and each product Xⱼ has a price pⱼ. Further, an exemplary consumer can be assumed to have some disposable income I which generates a money utility Uₘ(I). The decision to purchase X can generate a product utility Uₚ(Xⱼ) and, simultaneously, paying the price pⱼ can decrease the money utility to Uₘ(I−pⱼ). Assuming that the exemplary consumer strives to optimize its own utility, the purchased product Xⱼ can be assumed to be the one that gives the highest increase in utility. This exemplary approach can generate a ranking order for the products. The exemplary products that generate the highest increase in utility can be ranked on top. Thus, to determine and/or compute the increase in utility, the exemplary embodiment can determine the gained utility of product Uₚ(Xⱼ) and the lost utility of money Uₘ(I)−Uₘ(I−pⱼ).

Exemplary systems, apparatus, method and computer-readable medium according to exemplary embodiments of the present disclosure can use a hedonic price model that assumes that differentiated products are described by vectors of objectively measured characteristics. In addition, the utility that an exemplary consumer has for a product can be decomposed into a set of utilities for each exemplary product characteristic. According to this model, a product X with K features can be represented by a K-dimensional vector X=[x¹, . . . , x^{K}], where x^{k} can represent the amount or quality of the k-th characteristic of the product. The overall utility of product X can then be modeled by the function Uₚ(x¹, . . . , x^{K}). One of the issues in this model is how to estimate the aggregated utility from the individual product characteristics. Based on the hedonic price model, exemplary systems, apparatus, method and computer-readable medium can assume that each product characteristic is associated with a weight that can represent consumers' desirability towards that characteristic. Under this assumption, the exemplary systems, apparatus, method and/or computer-readable medium can further refine the definition of overall utility to be the aggregation of weighted utilities from the observed individual characteristics and an unobserved characteristic ξ:

$${U}_{p} ( X ) = {U}_{p} ( {x}^{1} , … , {x}^{K} ) = {\sum }_{k = 1}^{K} {β}^{k} \cdot {x}^{k} + ξ , \qquad ( 1 )$$

where β^{k} can represent the corresponding weight that the consumer assigns to the k-th characteristic x^{k}. Notice that with ξ we capture the influence of all product characteristics that are not explicitly accounted for in the exemplary embodiment. Thus, an exemplary product that consumers perceive as high-quality due to a characteristic not explicitly captured in exemplary measurements (e.g., brand name), can end up having a high value of ξ.

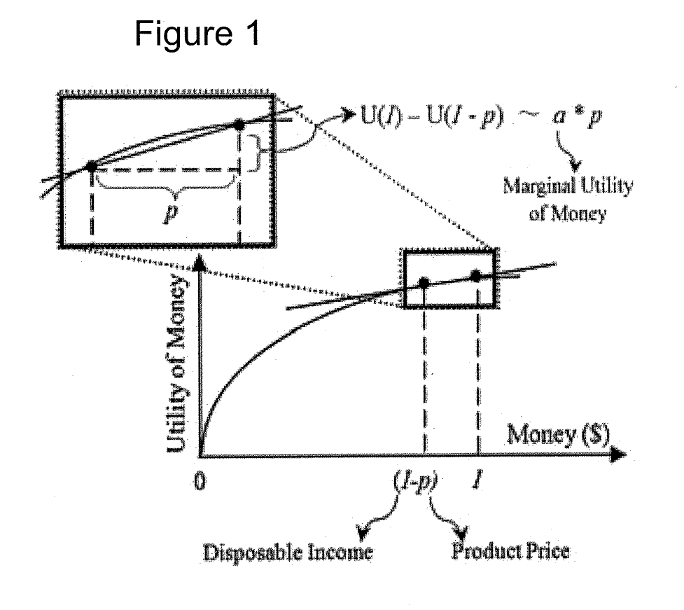

Given the utility of a product, to analyze consumers' motivation to trade money for the product, exemplary embodiments can also determine the utility of money. This exemplary concept can be viewed as consumers' happiness for owning monetary capital. Based on established economic principles, utility of money can have two basic properties: increasing and concave. For example, an increase in the amount of money will or can be assumed to cause an increase in the utility of money. In other words, the more money someone has, the higher the utility of that sum. Further, the increase in utility, or marginal utility of money, can diminish as the amount of money increases, e.g., the increase is concave or logarithmic. Based on these properties, an example of the utility function for money is shown in FIG. 1. For example, with the concave form of the utility function of FIG. 1, the slope is decreasing, thus the marginal utility of money is diminishing. In other words, e.g., $100 can be more important for someone with, e.g., $1,000 than for someone with e.g., $100,000.

This can also imply that consumers are risk-averse under normal circumstances. For example, given the same probability to win or lose, losing some amount, e.g., N dollars in assets can cause a drop in the utility larger than the boost of winning the same N dollars. Exemplary embodiments may relax this concave assumption when the changes in money are small. For most transactions, exemplary embodiments can assume that the marginal utility of money is approximately constant. Therefore, the exemplary systems, apparatus, method and/or computer-readable medium can assume that a consumer with a particular income I receives a money utility Uₘ(I). Paying the price p decreases the money utility to Uₘ(I−p). Assuming that p is relatively small compared to the disposable income I, the marginal utility of money can be assumed to remain mostly constant in the interval [I−p, I]. Under this exemplary assumption, the utility of money that the consumer will lose by paying the price p for product X, can be thereby represented in a quasi-linear form as follows:

Uₘ(I)−Uₘ(I−p)=α·I−α·(I−p)=)α(I)·p, (2)

where α(I) denotes the marginal utility for money for someone with disposable income I.

Given the utility of a particular product and the utility of money, the exemplary systems, apparatus, method and/or computer-readable medium can derive the utility surplus as the increase in utility, or excess utility, after the purchase. One exemplary mathematical definition for utility surplus can be provided as follows: the utility surplus (US), for a consumer with disposable income I, when buying a product X priced at p, is the gain in the utility of product Up minus the loss in the utility of money Um.

$$\begin{matrix}US = {U}_{p} ( X ) - [ {U}_{m} ( I ) - {U}_{m} ( I - p ) ] + {ɛ}_{j}^{i} \\ = \underbrace{{\sum }_{k}^{ } {β}^{k} \cdot {x}^{k} + ξ}_{Utility of product} - \underbrace{α \cdot p}_{Utility of money} + \underbrace{ɛ}_{Stochastic error}\end{matrix} \qquad ( 3 )$$

For example, ξ can be a product-specific disturbance scalar summarizing unobserved characteristics of product X, and ε can be a stochastic error term that is assumed to be independent and identically distributed (“i.i.d.”) across products and consumers in the selection process and can be assumed to follow a Type I extreme-value distribution. In this exemplary context, an aspect of certain exemplary embodiments can be to estimate the corresponding weights assigned by consumers towards money and product dimensions.

Identifying these weights can be performed on the consumer level, e.g., for a particular consumer with a particular disposable income and particular product needs, weights can be accurately identified. However, the exemplary systems, apparatus, method and/or computer-readable medium can identify approximate weights even though at least some specific consumer data remains private and not directly observable. The exemplary systems, apparatus, method and/or computer-readable medium can observe the behavior of consumers and estimate the values of these latent parameters that best explain the consumer behavior. The exemplary estimates can be derived from anonymous data without requiring observation of the behavior of individual consumers, and without requiring explicit inquiry of each consumer for their personal “tastes” (e.g., choice of a product “weight” assigned to a product feature, etc.). Instead, exemplary embodiments can extract utility estimates and derive individual preferences by using aggregate data.

When the exemplary systems, apparatus, method and/or computer-readable medium determine and/or calculate the utilities of different products for a consumer, the demand for different products can be estimated, since consumers can be assumed to behave according to their utility-encoded preferences. For example, if the exemplary systems, apparatus, method and/or computer-readable medium observe the demand for various products, they can then infer the preferences of the consumer population for different product aspects. According to one exemplary method for observing product demand, it is possible to include an observation of a sales-rank on a popular e-commerce website, e.g., Amazon.com® and transform that sales-rank to demand. According to another exemplary method for observing product demand, it is possible to directly observe the transactions at marketplaces such as eBay® and Amazon®, or by directly getting anonymous transactions from a merchant.

According to the exemplary systems, apparatus, method and/or computer-readable medium according to one exemplary embodiment of the present disclosure, it is possible to assume that consumers have “homogeneous preferences” towards product characteristics. In other words, the exemplary weights, and a are common across all consumers. For this exemplary embodiment, the utility surplus for consumer i and product j can be written as:

USⱼⁱ=Vⱼ(α,β)+εⱼⁱ. (4)

where Vⱼ(α,β)=Σₖβ^{k}·xⱼ^{k}+ξⱼ−α·pⱼ. The exemplary systems, apparatus, method and/or computer-readable medium can separate preferences towards product j, captured by Vⱼ(α,β), from non-deterministic aspects of individual consumer behavior, captured by the error term εⱼⁱ. According to the assumption of consumer rationality for utility maximization, the consumer can select the product that maximizes utility surplus. The choice is stochastic, given the error term εⱼⁱ. Therefore, in this exemplary embodiment, the probability that a consumer i chooses product j can be:

P(P(USⱼⁱ>USₗⁱ)(∀l in the same market,l≠j). (5)

Solving this equation, yields:

$$P ( {choice}_{j}^{i} ) = \frac{exp ( {V}_{j} ( α , β ) )}{1 + {\sum }_{l}^{ } exp ( {V}_{l} ( α , β ) )} . \qquad ( 6 )$$

In the exemplary homogeneous case, all consumers have the same α and β and this probability can be proportional to the market share of product j (the consumer-specific error term εⱼⁱ has disappeared). At this point, the problem of estimating preferences can be expressed as a logistic regression problem. From Equation 6, the exemplary systems, apparatus, method and/or computer-readable medium can estimate consumer preferences (expressed by the parameters α and β), by observing market shares of the different products.

The exemplary systems, apparatus, method and/or computer-readable medium can identify an exemplary “demand” for the “buy nothing” option in order to estimate properly the value P(choiceⱼ) in Equation 6. Specifically, the exemplary systems, apparatus, method and/or computer-readable medium can set P(choiceⱼ)=dⱼ^{obs}/dₜₒₜₐₗ, where dⱼ^{obs} is the observed demand for product j and dₜₒₜₐₗ is “total demand,” which includes the demand for the buy-nothing option. Taking logs in Equation 6 and solving the system yields:

$$ln ( {d}_{j}^{obs} ) = - α \cdot {p}_{j} + {\sum }_{k}^{ } {β}^{k} \cdot {x}_{j}^{k} + {ξ}_{j} . \qquad ( 7 )$$

The exemplary systems, apparatus, method and/or computer-readable medium, using such exemplary model, can then easily solve for the parameters β and α using any linear regression method, such as ordinary least squares (OLS). Returning to the hotel example, it can be assumed that there is a hotel market in New York, with two hotels, Hotel M (Mandarin Oriental®, 5-star), and Hotel D (Doubletree®, 3-star). From day 1 to 3, an exemplary embodiment observes that the price for Hotel M is $500, $480 and $530 per night. The exemplary systems, apparatus, method and/or computer-readable medium can further observe a corresponding demand of 400, 470, and 320 bookings, respectively. Meanwhile, the price for Hotel D is $250, $270 and $225 per night, and its corresponding demand is 600, 530 and 680 bookings. Using the exemplary model, it is possible to calculate the regression equations:

ln(bookings)=−α·price+β·stars+fₕₒₜₑₗ+ε (8)

Thus, the exemplary systems, apparatus, method and/or computer-readable medium can divide the unobservable ξ into a fixed effect f that is common for the same hotel (e.g., a dummy binary variable), and an i.i.d. random error term ε. Using OLS, the exemplary embodiment can calculate α=0.0067 and β=0.64 which can express the sensitivity of the consumers to price and their preference for “stars,” respectively.

The assumption of homogeneity of consumer preferences is a simplified case. In reality, consumers can be different and their tastes can vary. To facilitate the preferences to vary, though, the exemplary systems, apparatus, method and/or computer-readable medium can assume that preferences are a function of consumer demographics and purchase context. For example, everything else being equal, honeymooners may appreciate a hotel in a romantic remote setting, while business travelers may appreciate a location with easy access to public transportation. Travel categories can include a number of trip purposes, such as family trip, business trip, romantic trip, tourist trip, trip with kids, trip with seniors, pet friendly trip, and disability friendly trip. Hotels can be classified into a specific travel category based on reviewers' most frequently mentioned travel purpose for that hotel. Each hotel can belong to a single travel category, or in other exemplary embodiments, hotels can have multiple categories (e.g., based on a threshold percent or quantity of reviews identifying that purpose). To capture the heterogeneity in consumers' travel purpose, exemplary embodiments can introduce an idiosyncratic taste shock at the travel category level. This shock is similar to the product-level taste shock in the BLP model.

The exemplary systems, apparatus, method and/or computer-readable medium can therefore characterize each customer by a set of demographic characteristics (e.g., age, gender, travel purpose, etc.) and make the preference coefficients β to be a function of these demographics. In this case, the overall preference distribution of the whole population can be a mixture of preference distribution of the various consumer types in the population.

The exemplary systems, apparatus, method and/or computer-readable medium can observe overall demand, and need not observe the demand from each separate consumer group. Tailored preferences from aggregate data can be determined in the exemplary embodiments by monitoring demand for similar products in different markets, for which the distribution of consumers is known. Since the same product will have the same demand from a given demographic group, any differences in demand across markets can be attributed to the different demographics. The exemplary systems, apparatus, method and/or computer-readable medium can define a “market” as the combination of “city-week” (i.e., location and time). Correspondingly, the exemplary embodiments can calculate the market share for each hotel based on the number of rooms sold for that hotel in that market (e.g., city-week) divided by the total size of that market. With regard to market size, the exemplary systems, apparatus, method and/or computer-readable medium can apply the same idea as in the demand estimation models, e.g., computing the market size by estimating the potential consumption in a market. For example, the exemplary systems, apparatus, method and/or computer-readable medium can estimate the total potential market consumption to be proportional to the total number of rooms available in the existing hotels in a certain market (including the hotels whose transactions appear in current choice sets and those whose transactions are not observed).

For example, there may be two cities, A and B and two types of consumers: business trip travelers and family trip travelers. Exemplary city A is a business destination with 80% of the travelers being business travelers and 20% families. Exemplary city B is mainly a family destination with 10% business travelers and 90% family travelers. In city A, there are two hotels: A₁ and A₂. In city B, we have again two hotels: B₁ and B₂. Brand one hotels (A₁, B₁) have a conference center but no pool, and brand two hotels (A₂, B₂) have a pool but no conference center. The example can assume that preferences of consumers do not change when they travel in different cities and that prices are the same. By observing demand, it can be seen that demand in city A (e.g., the business destination) is 820 bookings per day for A₁ (of brand one) and 120 bookings for A₂ (of brand two). In city B (e.g., the family destination) the demand is 540 bookings per day for B₁ (of brand one) and 460 bookings for B₂ (of brand two). Since the hotels are brand identical in the two cities, and thus assumed to be substantially identical in features, the changes in demand can be assumed to be the result of different traveler demographics, hinting that a conference center is desirable for business travelers.

According to certain exemplary embodiments of the present disclosure, it is possible to extract consumer preferences by using, e.g., the Random-Coefficient Model, commonly referred to as the BLP model. This model extends the basic Logit model by assuming the coefficients β and α in Equation 6 to be demographic-specific. For example, let Tⁱ be a vector representing consumer type, which can specify a particular purchase context, age group, and so on. In the simplest case, the exemplary systems, apparatus, method and/or computer-readable medium can utilize a binary variable for each consumer group. With the preferences being demographic-specific, the exemplary systems, apparatus, method and/or computer-readable medium can determine the utility surplus for consumer i, of type Tⁱ, when buying product j, with features [x¹ⱼ, . . . , x^{k}ⱼ], at price pⱼ to be:

$${US}_{j}^{i} = {\sum }_{k}^{ } {β}^{k} ( {T}^{i} ) \cdot {x}_{j}^{k} - α ( {I}^{i} ) \cdot {p}_{j} + {ξ}_{j} + {ɛ}_{j}^{i} . \qquad ( 9 )$$

For the Logit model, e.g., in Equation 4, according to other exemplary embodiments, it is possible to use V (α, β) to stylistically separate the population preferences from the idiosyncratic behavior of the consumer. The exemplary systems, apparatus, method and computer-readable medium can perform the same or substantially the same function for the BLP model, separating the mean population preferences from the demographic-specific preferences. So, we write β^{k}(Tⁱ)=( β̅^̅{̅k̅}̅+β_{T}^{k}\check{T}ⁱ, where β̅^̅{̅k̅}̅ is the mean of the preference distribution, and β^{k}_{T} is a vector capturing the variation in the preferences from different consumer types. Similarly, the exemplary embodiment can model αⁱ as a function of income Iⁱ: α(Iⁱ)=( α̅+α_{I}Iⁱ). The exemplary systems, apparatus, method and/or computer-readable medium can assume α_{I} and β_{T} to be independent. Thus, the exemplary systems, apparatus, method and/or computer-readable medium can therefore rewrite USⁱⱼ as:

$${US}_{j}^{i} = {\sum }_{k}^{ } ( {\overline{β}}^{k} + {β}_{T}^{k} {T}^{i} ) \cdot {x}_{j}^{k} + {ξ}_{j} - ( \overline{α} + {α}_{I} {I}^{i} ) \cdot {p}_{j} + {ɛ}_{j}^{i} . \qquad ( 10 )$$

Further, the exemplary systems, apparatus, method and/or computer-readable medium can use δⱼ=− α̅·pⱼ+Σₖ β̅^̅{̅k̅}̅·xⱼ^{k}+ξⱼ to represent the mean utility of product j. Then, similar to the Logit model, it is possible to use such exemplary embodiments of the present disclosure to derive the choice probability for j, by integrating over the population demographic and income distributions P(T) and P(I):

$$P ( {choice}_{j} ) = \int \frac{exp ( {δ}_{j} + {α}_{I} {I}^{i} {p}_{j} + {\sum }_{k}^{ } {β}_{T}^{k} {T}^{i} {x}_{j}^{k} )}{1 + {\sum }_{l}^{ } exp ( {δ}_{l} + {α}_{I} {I}^{i} {p}_{l} + {\sum }_{k}^{ } {β}_{T}^{k} {T}^{i} {x}_{l}^{k} )} d P ( T ) d P ( I ) \qquad ( 11 )$$

The exemplary systems, apparatus, method and/or computer-readable medium of the present disclosure can base rankings on a computation of this integral (e.g., in Formula 11). First, exemplary embodiments can calculate values for the unknown parameters. In general, the exemplary embodiments can estimate the parameters by searching the parameter space in an iterative manner, using the following steps:
1. Initialize the parameters δⱼ⁽⁰⁾ and θ⁽⁰⁾=(α_{I}⁽⁰⁾, β_{T}⁽⁰⁾) using a random choice of values.
2. Estimate market shares sⱼ given θ and δ.
3. Estimate most likely mean utility δⱼ given the market shares.
4. Find the best parameters α̅ and β̅^̅{̅k̅}̅ that minimize the unexplained remaining error in δⱼ and evaluate the generalized method of moments (“GMM”) objective function.
5. Use an algorithm (e.g., Nelder-Mead Simplex algorithm) to update the parameter values for θ=(α_{I}, β_{T}) and repeat from Step 2, until minimizing the GMM objective function.

To form the market equations (e.g., model predicted market share=observed market share), the exemplary systems, apparatus, method and/or computer-readable medium can utilize, e.g., the right-hand side sⱼ^{obs} that can be observed from transaction data, and the left-hand side sⱼ, derived from Equation 11.

The integral in Equation 11 might not be analytic. Thus, to approximate the integral, exemplary embodiments can “generate” a consumer randomly, given the demographic distribution, with a known demographic and income and, therefore, known preferences. Next, using a standard Logit model (e.g., Equation 6), the exemplary systems, apparatus, method and/or computer-readable medium can generate the choice of the product for this consumer. For example, assume the following joint demographic distribution of travel purpose and age group:

$$[ \begin{matrix} & Age \leq 45 & Age > 45 \\ Business & 15 \% & 15 \% \\ Family & 30 \% & 40 \%\end{matrix} ]$$

In this case, the exemplary systems, apparatus, method and/or computer-readable medium may have, e.g., about 40% probability of generating a “sample consumer” with family travel purpose and age above 45. By repeating the process and obtaining N_{T} samples of demographics Tⁱ and N_{I} samples of income Iⁱ, exemplary embodiments can compute an unbiased estimator of the Equation 11 integral:

$${s}_{j} ( {δ}_{j} \vert θ ) \sim \frac{1}{{N}_{I}} \frac{1}{{N}_{T}} {\sum }_{{I}^{i}}^{{N}_{I}} {\sum }_{{T}^{i}}^{{N}_{T}} \frac{exp ( {δ}_{j} + {α}_{I} {I}^{i} {p}_{j} + {\sum }_{k}^{ } {β}_{T}^{k} {T}^{ik} {x}_{j}^{k} )}{1 + {\sum }_{l}^{ } exp ( {δ}_{l} + {α}_{I} {I}^{i} {p}_{l} + {\sum }_{k}^{ } {β}_{T}^{k} {T}^{ik} {x}_{l}^{k} )} . \qquad ( 12 )$$

After the exemplary systems, apparatus, method and/or computer-readable medium determine market share from the parameters, the exemplary embodiment can then find a value of δⱼ that best “fits” the observed market shares. (It is noted that, conditional on θ=(α_{I}, β_{T}), market share sⱼ can be viewed as a function of the mean utility δⱼ). The exemplary systems, apparatus, method and/or computer-readable can apply a contraction mapping method, which can indicate the determination of the value for δ using an iterative approach:

δⱼ^{(t+1)}=δⱼ^{(t)}+(ln(sⱼ^{obs})−ln(sⱼ(δⱼ^{(t)}|θ))). (13)

The exemplary procedure can be proven to and/or guaranteed to converge and find δⱼ that satisfies sⱼ(δⱼ|θ)=sⱼ^{obs}. Once the exemplary embodiment has the market shares and the mean utility parameters, it can find the most likely demographic-specific weight deviations θ=(α_{I}, β_{T}). Different values for θ=(α_{I}, β_{T}) can lead to different mean utilities and market shares. Hence, the exemplary embodiments can utilize a criterion for identifying the best solution. The exemplary systems, apparatus, method and/or computer-readable can perform such procedure as follows. For example, the exemplary systems, apparatus, method and/or computer-readable can use Instrumental Variables (“IV”) to estimate the mean weights α̅ and β̅ₗ, and extract the unobserved error term ξ from the mean utility function:

$$ξ ( θ ) = δ ( θ ) - ( {\sum }_{k}^{ } {\overline{β}}^{k} \cdot {x}^{k} - \overline{α} \cdot p ) . \qquad ( 14 )$$

According to certain exemplary embodiments of the present disclosure, in the context of the exemplary hotel search, it is possible to use the average price of the “same-star rating” hotels in other markets as the instrument for price of a particular hotel to ensure that there is not a correlation of the error term with a variable in the regression. Then, using the generalized method of moments, the exemplary systems, apparatus, method and/or computer-readable can base the analysis on the moment condition where the mean of the unobserved error term ξ is uncorrelated with the instrumental variable IV. Thus, the objection function can be minimized as follows:

GMMobj(θ)=E[ξ′(θ)·IV]. (15)

When the exemplary systems, apparatus, method and/or computer-readable identify the mean utility for a given set of weight deviations θ=(α_{I}, β_{T}), the value of the GMM objective function GMM_{obj}(θ) can be derived. Then, the exemplary systems, apparatus, method and/or computer-readable can use, e.g., the Nelder-Mead Simplex algorithm to search for the optimal θ*=(α*_{I}, β*_{T}) that minimizes the GMM objective function. This exemplary process can eventually identify the heterogeneous weights that different consumers assign to product price, α(Iⁱ)= α̅*+α*_{I}·Iⁱ, and those being assigned to product characteristics, β(Tⁱ)= β̅*+β*_{T}·Tⁱ.

Returning to the previous business vs. family traveler example, e.g., the exemplary systems, apparatus, method and/or computer-readable can determine that, for a business traveler, the utility surplus from hotel A₁ (e.g., having a conference center, but no pool) is US^{B}(A₁)=δ_{A1}+(β^{B}_{conf}·1+β^{B}ₚₒₒₗ·0)+ε, and for family travelers, the corresponding utility surplus is US^{F}(A₁)=δ_{A1}+(β^{F}_{conf}·1+β^{F}ₚₒₒₗ·0)+ε. By β_{•}^{B}, the exemplary systems, apparatus, method and/or computer-readable can utilize the deviations from the population mean for business travelers towards “conference center” and “pool” and by β_{•}^{F} the exemplary embodiments denote the respective deviations for family travelers. Similarly, the exemplary embodiments can determine the utilities for hotels A₂, B₁ and B₂. Following the estimation steps discussed above, the exemplary systems, apparatus, method and/or computer-readable can determine that family travelers have β^{F}_{conf}=β^{F}ₚₒₒₗ=0.5. In other words, such exemplary travelers can have the same preferences regarding a pool and conference center. On the other hand, for business travelers, their preference towards “conference center” is much higher than towards “pool,” with β^{B}_{conf}=0.9 and β^{B}ₚₒₒₗ=0.1, respectively.

Accordingly, the exemplary systems, apparatus, method and/or computer-readable according to exemplary embodiments of the present disclosure can be primarily been directed toward models for inferring the preferences of consumers using a utility model and aggregate demand data. These exemplary models can use the concept of surplus mainly as a conceptual tool to infer consumer preferences towards different product characteristics. In further exemplary embodiments of the present disclosure, the concept of surplus can be directly used to find the product that is the “best value for money” for a given consumer.

According to one particular exemplary embodiment of the present disclosure, it is possible to use the estimated surplus for each product and rank the available products in decreasing order of surplus. Therefore, e.g., at the top there can be the products that are the “best value” for consumers, for a given price. Such exemplary systems, apparatus, method and/or computer-readable according to this exemplary embodiment can define Consumer Surplus for consumer i from product j as the “normalized utility surplus,” the surplus U̅S̅ⱼ⁽ⁱ⁾ divided by the mean marginal utility of money α̅.

$${CS}_{j} = {Normalized\_US}_{j} = {\sum }_{t}^{ } \frac{1}{\overline{α}} {US}_{j}^{( i )} . \qquad ( 16 )$$

In the general, non-personalized case, if th exemplary ranked products based on the “training” demand data then, in theory, the product ranking could be similar to a “best selling” ranking, e.g., the products that generate that largest surplus are the ones that would also generate the highest sales. (Notice that rational consumers may prefer the products that generate the highest surplus.) However, when ranking products that are available today, the surplus-based ranking can be different for a variety of reasons. First, the product price may have changed, making some products a better “value for money.” Second, there may be a new product in the market, or the value of some product features may be time-dependent (e.g., the value of being next to a lake may be positive during warm weather and negative during the winter). As such, new offerings, or changed offerings can have their new/changed utility calculated immediately, based on the historical data of what consumers consider important.

As indicated herein, the exemplary systems, apparatus, method and/or computer-readable according to certain exemplary embodiments of the present disclosure have primarily been described as being based on aggregate data, without needing personalized, e.g., private, user data. While the ability to provide personalized results, without the need of private data presents a powerful improvement over traditional systems, the exemplary systems, apparatus, method and/or computer-readable are not at all limited to public data, and can be even further refined via one or more pieces of user-specific data. In other words, other possible more beneficial results can be achievable for a user who indicates some user-specific value, by using coefficients derived from historical data of users with that same user-specific value. To determine the personalized surplus, it is possible to inquire from the consumer to provide the appropriate demographic characteristics and purchase context (e.g., 35-49 years old, male, $100K income, business traveler) and then use the corresponding deviation matrices β_{T} and α_{I}. The exemplary systems, apparatus, method and/or computer-readable can then determine and/or compute the personalized “value for money” for this individual consumer, and rank products accordingly

For example, consider the previous setting of the two hotels A₁ and A₂ for city A. Suppose that two consumers are traveling to city A on the same day: C₁, a 35-49 years old business traveler, with an income $50,000-100,000, and C₂, a 25-34 years old family traveler, with an income less than $50,000. Since these two travelers belong to different demographic groups and travel with different purposes, their preferences towards “conference center” and “pool” are different. Thus, the surplus they obtain from A₁ and A₂ varies. For example, the business traveler gets higher utility from A₁ due to the specialized conference center services, whereas the family traveler finds A₂ more valuable due to the pool and price. This personalization component can allow each consumer to identify the product that is the “best value for the money.”

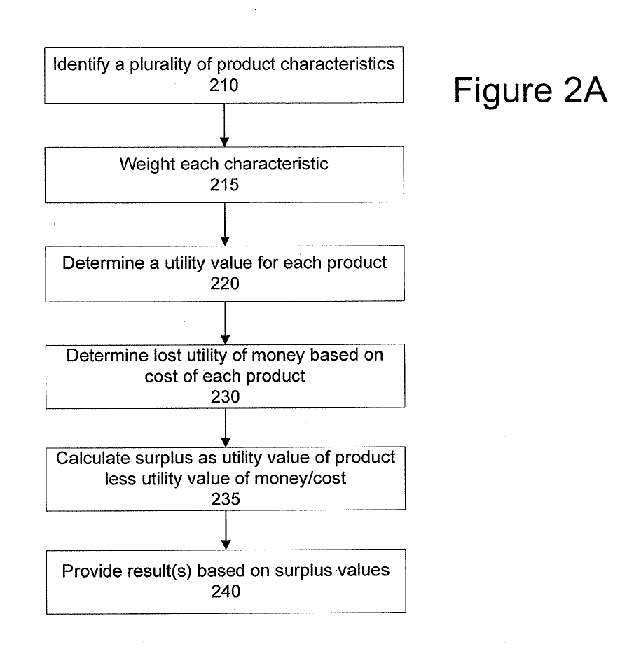

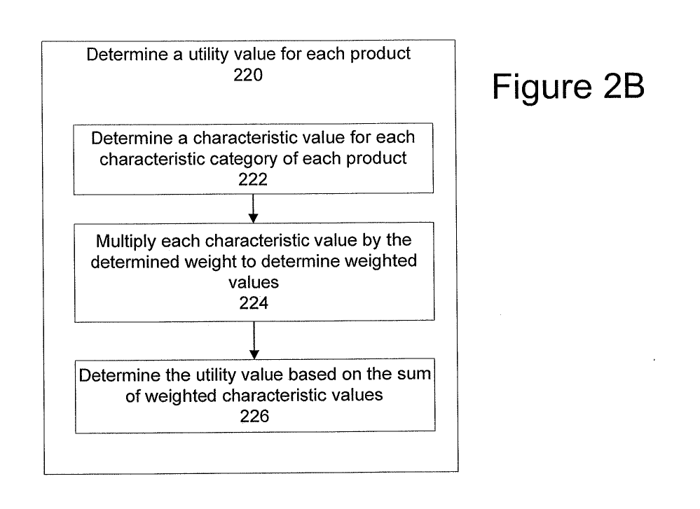

FIG. 2A illustrates a flow diagram of an exemplary method for providing surplus based results according to an exemplary embodiment of the present disclosure. First, at procedure 210, the exemplary method can identify a plurality of product characteristics. In the example of hotels, this can include a star rating, booking demand, user reviews, presence of a pool, conference center, internet access, etc. Next, at procedure 215, the exemplary embodiment can weight each characteristic, e.g., as described above in the context of the exemplary economic modeling. Next, at 220, the exemplary method can determine and/or calculate an overall utility value for each product. One exemplary method for determining the value in procedure 220 is illustrated in the exemplary method of FIG. 2B. Next, at procedure 230, the exemplary method can calculate the utility of money that will be lost based on the associated cost of each product. At procedure 235, the surplus can be calculated as the overall utility value, less the utility of the traded money/cost. Finally, at procedure 240, the exemplary method can provide a result based on each determined surplus value. This exemplary result can include the single best product/service, or a ranked list of the best values.

FIG. 2B illustrates a flow diagram of an exemplary procedure for determining the overall utility value for each product, e.g., as performed in procedure 220 shown in in FIG. 2A. First, at procedure 222, the exemplary method can determine a characteristic value for each characteristic category of each product. For example, a characteristic category can be star rating, as determined by some particular user review site, or group of sites, and the characteristic value for a particular hotel can be some value between 1 and 5, corresponding to the star-rating associated with that particular hotel. Next, at procedure 224, the individual values can be weighted relative to their respective importance (e.g., as discussed above in the context of the exemplary models). These weights or characteristic values can be dependent on context. For example, a pool characteristic can have a binary value (pool or no pool), may have other values (e.g., a 1-to-5 rating of the pool facilities), and may have a weight value. However, at a hotel in the north, the value or weight may drop significantly when searching in winter months, while indoor pools may increase some degree during winter months. When the values and weights are determined, a weighted sum can be determined as the overall utility of the particular product (e.g., at procedure 226).

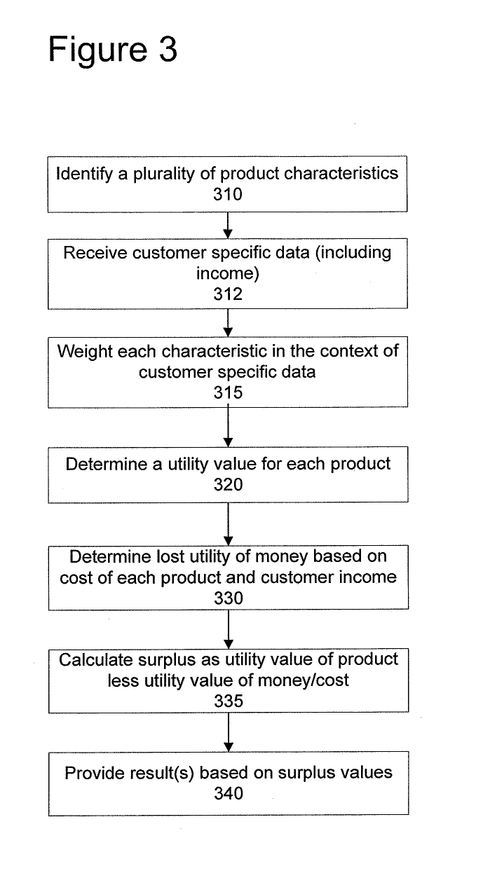

FIG. 3 illustrates a flow diagram of a an exemplary method for providing surplus based results in a particular context (e.g., knowing at least some broad customer-specific data) according to another exemplary embodiment of the present disclosure. First, at procedure 310, the exemplary method can identify a plurality of product characteristics. In the example of hotels, this can include a star rating, booking demand, user reviews, presence of a pool, conference center, internet access, etc. Next, at procedure 312, the exemplary method can receive customer specific data, which can include the customer's income, and may include a number of other data points, such as age, reason for travel, etc. Next, at procedure 315, the exemplary method can weight each characteristic, e.g., as described above in the context of the exemplary economic modeling, within the context of the customer-specific data. This can include a significantly lower pool weighting for the business traveler, etc. Next, at procedure 320, the exemplary method can determine and/or calculate an overall utility value for each product. Further, at procedure 330, the exemplary method can determine and/or calculate the utility of money that will be lost based on the associated cost of each product. As illustrated in FIG. 1, this utility value can be determined based on customer-specific financial/income data. For example, the subtracted utility of some fixed amount (e.g., $200) can be greater for customers indicating a lower income than for customers indicating a higher income. At 335, the surplus can be calculated as the overall utility value, less the utility of the traded money/cost. Finally, at procedure 340, the exemplary method can provide a result based on each determined surplus value. This exemplary result can include the single best product/service, or a ranked list of the best values.

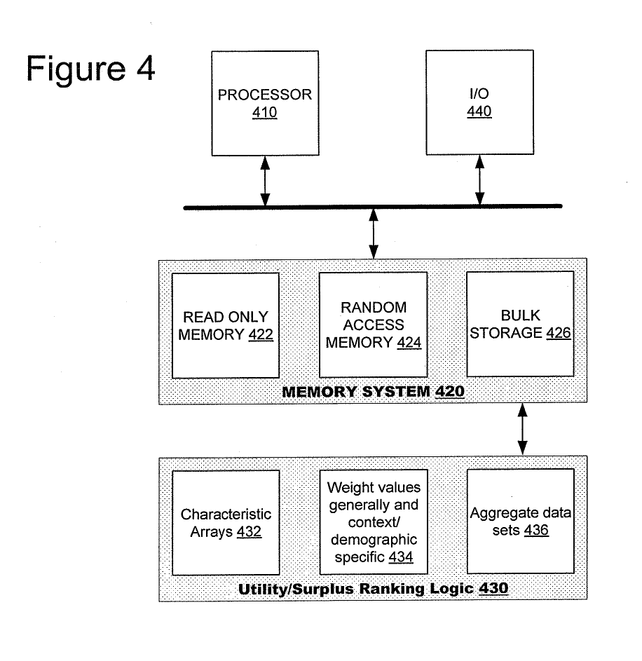

FIG. 4 illustrates a flow diagram of an exemplary system and exemplary machine readable medium, e.g., memory system 420 according to an exemplary embodiment of the present disclosure. For example, the exemplary system can include a processor 410, connected to a storage system and/or a memory system 420, and an I/O system 440. The exemplary system can store data and/or instructions, including utility surplus ranking logic 430, having characteristic arrays 432, weight values (e.g., both generally and for context/demographic specific searches) 434, and aggregate data sets 436. Indeed, such exemplary system can implement each and every exemplary procedure and method described herein, and the storage system and/or memory system 420 can store one or more computer programs thereon which can be retrieved and/or executed by the processor 410 to perform such exemplary procedures and/or methods.

While the utility and surplus based search result alone can provide a significant improvement over traditional systems, the exemplary embodiments can also leverage user-generated content, such as reviews, ratings, pictures, etc. in an integrated model of identifying the best value results. According to certain exemplary embodiments of the present disclosure, it is possible to use consumer utility procedures to design a scalar utility score with which to rank items (e.g., products and/or services) while incorporating all the dimensions of quality observed from diverse information sources.

The exemplary systems, apparatus, method and/or computer-readable can determine the particular item (e.g., hotel) characteristics customers value most, and thus influence the aggregate demand of those items. Beyond the directly observable characteristics (e.g., the “number of stars”) most third-party travel websites provide, many users also tend to value specific location characteristics, such as proximity to the beach or to downtown. These exemplary features can be identified in a number of ways, such as from satellite image classification techniques and both human and computer intelligence (in the form of social geo-tagging and text mining of reviews) to infer these location features. These mined or determined features can then be characteristics, with utility coefficients, that contribute to the “sum of characteristics” utility measure of an item, e.g., as described in the exemplary embodiments.

The exemplary systems, apparatus, method and/or computer-readable according to certain exemplary embodiments of the present disclosure can use five location-based characteristics that have a positive impact on hotel demand: number of external amenities, presence near a beach, presence near public transportation, presence near a highway, and presence near a downtown. The textual content and style of reviews can also demonstrate a statistically significant association with demand. For example, reviews that are less complex, have shorter words, and have fewer spelling errors influence demand positively, as do reviews with more characters and those written in simple language. Reviews that contain objective information, (such as factual descriptions of hotels) rather than subjective information can have a positive correlation, as can third party information over hotel-provided descriptions. Statistical evidence shows that consumers also prefer to stay in hotels with reviews written in a “consistent objective style” rather than a mix of objective and subjective sentences, and exemplary embodiments can weight the associated characteristic utility accordingly.

The exemplary systems, apparatus, method and/or computer-readable can collect customer reviews from various booking sites, as well as from more neutral sites, such as the online travel community TripAdvisor.com. The exemplary systems, apparatus, method and/or computer-readable can use the total number of reviews and the numeric reviewer rating to control for word-of-mouth effects. In addition, exemplary embodiments can account for the actual quality of the reviews by analyzing text style features, such as subjectivity and readability. Certain exemplary embodiments can include five broad types of characteristics in this category: (i) total number of reviews, (ii) overall review rating, (iii) review subjectivity (mean and variance), (iv) review readability (the number of characters, syllables, and spelling errors, complexity, and SMOG Index), and (v) disclosure of the reviewer's identity.

The exemplary systems, apparatus, method and/or computer-readable according to further exemplary embodiments of the present disclosure can more fully exploit the information about hotel service characteristics from the data, which is embedded in the natural language text of the consumer reviews. For example, the helpfulness of the hotel staff is a service feature one can assess by reading the consumer opinions. Exemplary embodiments can extract the hotel features with an automated approach, including a POS (part-of-speech) tagger to identify the frequently mentioned nouns and noun phrases, which can include candidate hotel features. The exemplary systems, apparatus, method and/or computer-readable can then use new or known context-sensitive hierarchical agglomerative clustering algorithms to further cluster the identified nouns and noun phrases into clusters of similar nouns and noun phrases. The resulting set of clusters can correspond to the set of identified product features mentioned in the reviews. For example, it is possible to keep the top five most frequently mentioned features, which can include: hotel staff, food quality, bathroom quality, parking facilities, and bedroom quality.

For sentiment analysis, the exemplary systems, apparatus, method and/or computer-readable can extract all the evaluation phrases (adjectives and adverbs) that are being used to evaluate the individual service features (for example, for the feature “hotel staff” exemplary embodiment can extract phrases like “helpful,” “smiling,” “rude,” “responsive,” etc). The exemplary process of extracting user evaluation phrases can also be automated. Exemplary embodiments can measure the meaning of these evaluation phrases, by using an automated method and/or receiving data from manual assessments (e.g., by using Amazon® Mechanical Turk® “AMT” or similar service) to exogenously assign explicit polarity semantics to each word. To compute the scores, exemplary embodiments can again use AMT to create an ontology, with the scores for each evaluation phrase. Further, to handle the negation (e.g., “I didn't think the staff was helpful”), it is possible to build or use a dictionary database to store all the negation words (e.g., not, hardly) using new or known approaches in text mining.

The exemplary systems, apparatus, method and/or computer-readable using this extended exemplary model can simplify the basic model framework by making two assumptions: (i) Dᵢ can contain only the consumer income, Iᵢ; and (ii) Π can be zero in all but one row, which can correspond with the price coefficient. However, other consumer demographic characteristics can also affect consumers' tastes. Moreover, other interaction effects might also exist beyond the one between income and price. Based on the basic model, certain exemplary embodiments can now relax these assumptions by considering interaction effects with the demographic variables, by facilitating interactions between consumer travel purposes and hotel characteristics. More specifically, the basic model can be extended in certain exemplary embodiments by allowing Dᵢ to contain both consumer travel purposes and income. It is also possible to facilitate Π to be non-zero in all its elements, whereas Tᵢ can be defined as an indicator vector with identity components representing consumer travel purpose:

Tᵢ′=[FamilyᵢBusinessᵢRomanceᵢTouristᵢKidSᵢSeniorsᵢDisabilityᵢ].

For example, if consumer i is on a business trip, the corresponding travel purpose vector can be: Tᵢ′=[0 1 0 0 0 0 0 0]. Thus, the extended model can be rewritten as:

uᵢⱼ_{^{k}}ₜ=δⱼ_{^{k}}ₜ+Xⱼ_{^{k}}ₜβ_{I}Iᵢ+Xⱼ_{^{k}}ₜβ_{I}Tᵢ+Xⱼ_{^{k}}ₜβᵥvᵢ+α_{I}IᵢPⱼ_{^{k}}ₜ+α_{T}TᵢPⱼ_{^{k}}ₜ+αᵥvᵢPⱼ_{^{k}}ₜ+εᵢⱼ^{k}. (17)

The exemplary use of an extended model can include a number of exemplary characteristics, as discussed herein. Empirical testing results can indicate that at least five location-based characteristics can be used with a positive impact on hotel demand: external amenities, beach, public transportation, highway, and downtown. Hotels providing easy access to public transportation (e.g., subways or bus stations), highway exits, restaurants, shops, or a downtown area can have a much higher demand. “Beach” also has a positive impact on demand. Most beach-based hotels can be located in areas where weather typically stays warm year round. Therefore, the desirability of a “walkable” beachfront can be shown to not lessen even in the winter.

Two location-based characteristics can have a negative impact on hotel demand: annual crime rate and a lake. The higher the average reported crime rate in a local area, the lower the desirability of that area's hotels. This result indicates that neighborhood safety can play an important role in the hotel industry. While it is possible to expect people to choose—rather than avoid—a hotel near a lake, many waterfront-based hotels are located in places where the weather becomes extremely cold during the winter season. A waterfront location can therefore be less desirable to travelers in winter.

To further examine the impact of lakefront locations, the exemplary systems, apparatus, method and/or computer-readable can collect weather data, e.g., from the National Oceanic and Atmospheric Administration (NOAA), on the average temperature during relevant periods (e.g., the periods covered by sets of aggregate training data) for all cities in the dataset. Then, e.g., it is possible to define dummy variables, e.g., “high temp,” which equals 1 if the average temperature is higher than, e.g., 50 degrees, and “low temp,” which equals 1 if the average temperature is lower than, e.g., 40 degrees. The exemplary systems, apparatus, method and/or computer-readable can then test “high temp” and “low temp” separately with “lake” in the exemplary model. Such exemplary results can show that the interaction of “low temp” with “lake” can have a significantly negative effect. Meanwhile, the interaction of “high temp” with “lake” can show a significantly positive effect, suggesting that warmer weather may help the lake area to attract more visitors. As a robustness check, the exemplary systems, apparatus, method and/or computer-readable can conduct a similar analysis for “beach” conditional on high and low temperatures. The exemplary results can illustrate a similar trend. Column 8 of Table 1 shows exemplary corresponding estimation results considering the interactions with the temperature.

Class (e.g., star rating) and amenity count can both have a positive impact on hotel demand. Hotels with a higher number of amenities and higher star-levels can have higher demand, controlling for price. Reviewer rating can also be positively associated with hotel demand. With regard to the “number of reviews” variable, there can be a positive sign for its linear form and a negative sign for its quadratic form. This finding indicates the economic impact from the customer reviews is increasing in the volume of reviews but at a decreasing rate. The textual quality and style of reviews can demonstrate a statistically significant association with demand. The readability and subjectivity characteristics can have a statistically significant association with hotel demand. Among the readability sub-features, complexity, syllables, and spelling errors can have a negative sign and therefore can be negatively associated with hotel demand. This finding can indicate that reviews with higher readability characteristics (shorter sentences and less complex words) and reviews with fewer spelling errors are positively associated with demand. On the other hand, the sign of the coefficients on “characters” and “SMOG index” can be shown to be positive, implying that longer reviews that are easier to read are positively associated with demand.

These findings indicate consumers can form a judgment about the quality of a hotel by judging the quality of the (user-generated) reviews. Both “mean subjectivity” and “subjectivity standard deviation” can be shown to be negatively associated with demand. This finding implies that consumers may believe reviews that contain objective information (e.g., factual description of a room) over reviews that contain subjective information (e.g., comfort of a room). With respect to the subjectivity standard deviation, findings can suggest people prefer a “consistent objective style” from online customer reviews compared to a mix of objective and subjective sentences. Another review-based characteristic can include “disclosure of reviewer identity.” This variable can demonstrate a positive association with hotel demand.

Besides the above qualitative implications, it is possible to also quantitatively assess the economic value of different hotel characteristics. More specifically, the exemplary systems, apparatus, method and/or computer-readable can examine the magnitude of marginal effects on hotel demand for the location-, service-, and review-based hotel characteristics. In one exemplary implementation, the presence of a nearby beach can increase hotel demand by 18.23% on average. In contrast, a nearby lake or river can decrease demand by 12.83%. Meanwhile, easy access to transportation and to highway exits can increase demand by 18.32% and 7.87%, respectively. Presence near a downtown can increase demand by 5.29%. With regard to service-based characteristics, a one-star increase in hotel class can lead to an increase in demand of 4.13% on average. Moreover, the presence of one more internal or external amenity can increase demand by 0.06% or 0.08%, respectively. Demand can decrease by 0.28% if the local crime rate increases by one unit.

With regard to the review-based characteristics, the SMOG index (which can represent the readability of the review text) can have the highest marginal influence on demand on average. One-level increase in the SMOG index can be associated with an increase in hotel demand by 9.3% on average. One-unit increase in the number of characters can be associated with an increase in hotel demand by 0.12%, whereas a one-unit increase in the number of spelling errors, syllables, or complexity can be associated with a decrease in hotel demand by 1.41%, 0.50%, and 1.18%, respectively. In terms of review subjectivity, a 10% increase in the average subjectivity level can be associated with a decrease in hotel demand by 1.55%, and a 10% increase in the standard deviation of subjectivity can reduce demand by 4.74%. Finally, a 10% increase in the reviewer identity-disclosure levels can be associated with an increase in hotel demand by 0.68%.

For example, during an implementation of certain exemplary embodiments described herein, relevant data collection sources, such as Travelocity displayed five reviews per page, whereas TripAdvisor displayed ten per page. To minimize the bias webpage design might cause, since some customers may only read the reviews on the first page of each site, certain exemplary embodiments may consider two more alternatives beyond the primary dataset. For example, dataset (II) with hotels that have at least five reviews, and Dataset (III) with hotels that have at least ten reviews. Controlling for brand effect, the estimation results from these three datasets are illustrated in columns 2-4 of Table 1. For normalization purpose, exemplary embodiment can use the logarithms of price, characteristics, syllables, spelling errors, crime rate, internal amenities, external amenities, and review count in all the analyses in this paper. Exemplary results are shown in Table 1, columns 5-7.

TABLE 1
Main Estimation Results

| | | | | | |
|---|---|---|---|---|---|
| | Coef. | Coef. | Coef. | Coef. | Coef. |
| Variable | (Std. Err)^{I} | (Std. Err)^{II} | (Std. Err)^{III} | (Std. Err)^{A1} | (Std. Err)^{A2} |

Means

| | | | | | | | | | | |
|---|---|---|---|---|---|---|---|---|---|---|
| Price^{(L)} | −.149*** | (.002) | −.146*** | (.003) | −.142*** | (.002) | −.149*** | (.007) | −.158*** | (.027) |
| CHARACTERS^{(L)} | .010*** | (.002) | .010*** | (.002) | .010*** | (.002) | .015*** | (.003) | .016*** | (.004) |
| COMPLEXITY | −.011*** | (.002) | −.012*** | (.002) | −.011*** | (.003) | −.013*** | (.003) | −.007** | (.003) |
| SYLLABLES^{(L)} | −.044*** | (.007) | −.045*** | (.008) | −.044*** | (.007) | −.038*** | (.006) | −.032*** | (.007) |
| SMOG | .079*** | (.020) | .077** | (.024) | .080** | (.028) | .065** | (.022) | .093** | (.033) |
| SPELLERR^{(L)} | −.125*** | (.003) | −.126*** | (.004) | −.129*** | (.004) | −.120*** | (.006) | −.131*** | (.008) |
| SUB | −.132*** | (.006) | −.141*** | (.005) | −.141*** | (.004) | −.149*** | (.009) | −.124*** | (.025) |
| SUBDEV | −.403*** | (.011) | −.412*** | (.009) | −.420*** | (.016) | −.437*** | (.021) | −.396*** | (.033) |
| ID | .058** | (.020) | .056* | (.025) | .066** | (.023) | .046 | (.034) | .031 | (.034) |
| CLASS | .035*** | (.009) | .034*** | (.008) | .041*** | (.009) | .040*** | (.010) | .043*** | (.009) |
| CRIME^{(L)} | −.024* | (.017) | −.025* | (.017) | −.020* | (.011) | −.019* | (.010) | −.015 | (.014) |
| AMENITYCNT^{(L)} | .005* | (.002) | .006* | (.003) | .006*** | (.001) | .007** | (.002) | .010** | (.004) |
| EXTAMENITY^{(L)} | .007*** | (.002) | .008*** | (.001) | .011*** | (.002) | .012*** | (.001) | .015*** | (.002) |
| BEACH | .155*** | (.003) | .156*** | (.004) | .167*** | (.004) | .160*** | (.017) | .165*** | (.021) |
| LAKE | −.109*** | (.031) | −.106*** | (.029) | −.108*** | (.031) | −.122*** | (.036) | −.117* | (.059) |
| TRANS | .158*** | (.003) | .163*** | (.007) | .175*** | (.007) | .165*** | (.006) | .162*** | (.008) |
| HIGHWAY | .067* | (.025) | .070** | (.025) | .075** | (.026) | .077*** | (.022) | .088** | (.030) |
| DOWNTOWN | .045*** | (.002) | .049*** | (.004) | .044*** | (.003) | .039*** | (.005) | .033*** | (.004) |
| TA_RATING | .039** | (.018) | .044** | (.020) | .038** | (.018) | .045** | (.019) | .046** | (.022) |
| TL_RATING | .034*** | (.008) | .035*** | (.008) | .035*** | (.007) | .039*** | (.010) | .048*** | (.012) |
| TA_REVIEWCNT^{(L)} | .186*** | (.043) | .182*** | (.041) | .188*** | (.045) | .190*** | (.041) | .175*** | (.035) |
| TA_REVIEWCNT\hat{ }2^{(L)} | −.053*** | (.005) | −.051*** | (.006) | −.052*** | (.006) | −.068*** | (.008) | −.076** | (.031) |
| TL_REVIEWCNT^{(L)} | .014*** | (.002) | .014*** | (.002) | .015*** | (.002) | .016*** | (.001) | .019*** | (.004) |
| TL_REVIEWCNT\hat{ }2^{(L)} | −.021*** | (.005) | −.023*** | (.005) | −.025*** | (.005) | −.027*** | (.004) | −.031*** | (.007) |
| Constant | .039*** | (.002) | .033*** | (.005) | .036** | (.006) | .044*** | (.010) | .057** | (.021) |

| | | | | | |
|---|---|---|---|---|---|
| Brand Control^{II} | Yes | Yes | Yes | Yes | Yes |
| Instruments | ^{(Comp)}Comp Price | Comp Price in | [symbol] | [symbol] | [symbol] |
| | in Other Markets | Other Markets | Other Markets | Google Trend | Dummies |
| Distribution of | Type I | Type I | Type I | Type I | Type I |
| idiosyncratic | Extreme Value | Extreme Value | Extreme Value | Extreme Value | Extreme Value |
| error term | | | | | |
| HIGH TEMP | — | — | — | — | — |
| HIGH TEMP × LAKE | — | — | — | — | — |
| HIGH TEMP × BEACH | — | — | — | — | — |

Interaction Effect (α [symbol] ) & Standard Deviations (αᵥ)

| | | | | | | | | | | |
|---|---|---|---|---|---|---|---|---|---|---|
| Price^{(L)} × Income^{(L)} | .023*** | (.002) | .026*** | (.002) | .021*** | (.002) | .017*** | (.003) | .014*** | (.004) |
| Price^{(L)} | .011 | (.101) | .014 | (.098) | .018 | (.103) | .022 | (.082) | .029 | (.116) |

Standard Deviations (βᵥ)

| | | | | | | | | | | |
|---|---|---|---|---|---|---|---|---|---|---|
| CLASS | .025*** | (.005) | .026*** | (.006) | .033** | (.014) | .028** | (.011) | .042* | (.024) |
| CRIME^{(L)} | .006 | (.011) | .012 | (.021) | .012 | (.018) | .016 | (.018) | .019 | (.016) |
| AMENITYCNT^{(L)} | .016 | (.029) | .023 | (.037) | .025 | (.044) | .020 | (.027) | .025 | (.038) |
| EXTAMENITY^{(L)} | .003 | (.014) | .005 | (.019) | .004 | (.020) | .006* | (.003) | .009 | (.015) |
| BEACH | .061*** | (.012) | .056*** | (.015) | .055*** | (.014) | .066*** | (.017) | .072* | (.039) |
| LAKE | .112* | (.078) | .104* | (.058) | .097* | (.056) | .114 | (.092) | .107* | (.060) |
| TRANS | .129** | (.054) | .118* | (.064) | .123** | (.061) | .122*** | (.028) | .124*** | (.024) |
| HIGHWAY | .065* | (.035) | .052 | (.043) | .068 | (.047) | .053 | (.047) | .077 | (.092) |
| DOWNTOWN | .031** | (.011) | .034*** | (.009) | .045*** | (.007) | .025*** | (.002) | .039*** | (.010) |

| | | | | | |
|---|---|---|---|---|---|
| GMM Obj Value | 8.689e−4 | 8.115e−4 | 7.345e−4 | 5.972e−4 | 6.001e−4 |

| | | | |
|---|---|---|---|
| | Coef. | Coef. | Coef. |
| Variable | (Std. Err)^{A3} | (Std. Err)^{T} | (Std. Err)^{N} |

Means

| | | | | | | |
|---|---|---|---|---|---|---|
| Price^{(L)} | −.143*** | (.005) | −.149*** | (.001) | −.156*** | (.009) |
| CHARACTERS^{(L)} | .010** | (.004) | .009*** | (.002) | .012*** | (.002) |
| COMPLEXITY | −.011*** | (.002) | −.011*** | (.001) | −.008** | (.003) |
| SYLLABLES^{(L)} | −.042*** | (.006) | −.043*** | (.006) | −.046*** | (.008) |
| SMOG | .072** | (.026) | .077** | (.027) | .083*** | (.021) |
| SPELLERR^{(L)} | −.129*** | (.004) | −.125*** | (.003) | −.125*** | (.006) |
| SUB | −.133*** | (.014) | −.135*** | (.007) | −.142*** | (.015) |
| SUBDEV | −.414*** | (.013) | -.400*** | (.010) | −.423*** | (.027) |
| ID | .057* | (.029) | .051* | (.026) | .044 | (.038) |
| CLASS | .036*** | (.008) | .034*** | (.009) | .034*** | (.002) |
| CRIME^{(L)} | −.022* | (.014) | −.022* | (.016) | −.021*** | (.003) |
| AMENITYCNT^{(L)} | .007*** | (.002) | .006* | (.003) | .006*** | (.001) |
| EXTAMENITY^{(L)} | .009*** | (.001) | .007*** | (.002) | .007*** | (.001) |
| BEACH | .153*** | (.010) | −.025*** | (.003) | .161*** | (.017) |
| LAKE | −.111** | (.041) | −.127 | (.092) | −.122** | (.049) |
| TRANS | .162*** | (.019) | .158*** | (.004) | .156*** | (.023) |
| HIGHWAY | .063** | (.022) | .066* | (.026) | .077*** | (.020) |
| DOWNTOWN | .046*** | (.009) | .042*** | (.001) | .045*** | (.003) |
| TA_RATING | .043** | (.019) | .042** | (.014) | .040** | (.018) |
| TL_RATING | .035*** | (.006) | .034*** | (.006) | .041*** | (.010) |
| TA_REVIEWCNT^{(L)} | .169*** | (.037) | .187*** | (.042) | .173*** | (.041) |
| TA_REVIEWCNT\hat{ }2^{(L)} | −.055*** | (.011) | −.052*** | (.004) | −.057*** | (.006) |
| TL_REVIEWCNT^{(L)} | .016*** | (.002) | .013*** | (.002) | .017** | (.006) |
| TL_REVIEWCNT\hat{ }2^{(L)} | −.024*** | (.004) | −.020*** | (.002) | −.025*** | (.005) |
| Constant | .034*** | (.009) | .041*** | (.003) | .037 | (.029) |

| Brand Control^{II} | Yes | Yes | | Yes |
|---|---|---|---|---|
| Instruments | BLP Style | Comp Price in | | Comp Price in |
| | Instruments | Other Markets | | Other Markets |
| Distribution of | Type I | Type I | | Normal |
| idiosyncratic | Extreme Value | Extreme Value | | Distribution |
| error term | | | | |
| HIGH TEMP | — | .078 | (.066) | — |
| HIGH TEMP × LAKE | — | .020*** | (.005) | — |
| HIGH TEMP × BEACH | — | .179*** | (.031) | — |

Interaction Effect (α_{y}) & Standard Deviations (αᵥ)

| | | | | | | |
|---|---|---|---|---|---|---|
| Price^{(L)} × Income^{(L)} | .025*** | (.004) | .021*** | (.005) | .032*** | (.008) |
| Price^{(L)} | .009 | (.088) | .016 | (.108) | .027 | (.071) |

Standard Deviations (βᵥ)

| | | | | | | |
|---|---|---|---|---|---|---|
| CLASS | .033*** | (.004) | .024*** | (.004) | .037** | (.014) |
| CRIME^{(L)} | .010 | (.007) | .007 | (.011) | .016 | (.018) |
| AMENITYCNT^{(L)} | .015 | (.026) | .015 | (.022) | .024 | (.035) |
| EXTAMENITY^{(L)} | .009 | (.016) | .003 | (.014) | .005 | (.004) |
| BEACH | .064*** | (.013) | .063*** | (.011) | .068*** | (.020) |
| LAKE | .101^{†} | (.067) | .114*** | (.021) | .117* | (.069) |
| TRANS | .117** | (.040) | .118** | (.049) | .133** | (.051) |
| HIGHWAY | .069** | (.024) | .067* | (.036) | .052 | (.076) |
| DOWNTOWN | .036** | (.014) | .032* | (.017) | .038*** | (.007) |

| | | | |
|---|---|---|---|
| GMM Obj Value | 7.145e−4 | 8.016e−4 | 6.638e−4 |

***Significant at a 0.1% level.
**Significant at a 1% level.
*Significant at a 5% level.
^{†}Significant at a 10% level.
^{I}Based on the main dataset (at least 1 review from either TA or TL).
^{II}Based on the main dataset with review count >=5.
^{III}Based on the main dataset with review count >=10.
^{A1}Alternative Instruments 1 - Lag Price with Google Trend
^{A2}Alternative Instruments 2 - Region Dummy variables (Northeast, South, Midwest, Southwest, West)
^{A3}Alternative Instruments 3 - BLP Style Instruments (Average characteristics of the same-star hotels in other markets)
^{(Comp)}In the main estimation, we used the average price of the “same-star rating” hotels in the other markets as instruments.
^{T}Based on dataset I, considering interactions of temperatures with “lake/river” and with “beach.”
^{N}Normal distribution of the idiosyncratic error term.
^{(L)}Logarithm of the variable. [symbol]
indicates data missing or illegible when filed

For comparison purposes, several exemplary models were implemented in different exemplary embodiments for testing. Such exemplary testing included three baseline models: the BLP model, the PCM model, and the nested Logit model with travel category at the top hierarchy. The main sample Dataset (I) was randomly partitioned into two parts: a subset with 70% of the total observations as the estimation sample, and a subset with 30% of the total observations as the holdout sample. To reduce a potential bias from the partition procedure, testing performed a 10-fold cross-validation. The validation process was conducted for the random coefficient model and the three baseline models. Furthermore, to examine the model's ability to capture a deeper level of consumer heterogeneity, testing compared an extended version of the model described above, with an extended version of the BLP model when incorporating additional interaction effects (i.e., travel purpose interacted with price and hotel characteristics). To examine the significance of the UGC-, location-, and service-based hotel characteristics, the testing compared the original hybrid model with the same model but excluding the UGC, location, and service variables, respectively.

Finally, to evaluate the usefulness of different aspects of UGC in modeling the demand, the testing further included conducting model comparison using the hybrid model but excluding the numerical ratings and the textual review features, respectively. The exemplary test also evaluated models without each of the textual features, such as readability, subjectivity, and reviewer-identity variables, respectively. Tables B1 to B8 contain the exemplary results. The results show conditioning on UGC variables can significantly improves a model's predictive power.

TABLE B1
In-sample Basic Model Validation Results

| | | BLP without | BLP with | | Nested |
|---|---|---|---|---|---|
| | | Random | Random | | Logit |
| | | Coef. on | Coef. on | | (Random |
| | Hybrid | Travel | Travel | | Utility |
| | Model | Categories | Categories | PCM | Maximization) |
| RMSE | 0.0407 | 0.0518 | 0.0485 | 0.0976 | 0.1158 |
| MSE | 0.0016 | 0.0027 | 0.0024 | 0.0095 | 0.0134 |
| MAD | 0.0133 | 0.0185 | 0.0167 | 0.0318 | 0.0379 |

TABLE B2
In-sample Extended Model Validation Results

| | Hybrid Model With | BLP with |
|---|---|---|
| | Interaction Effects | Interaction Effects |
| RMSE | 0.0347 | 0.0426 |
| MSE | 0.0012 | 0.0018 |
| MAD | 0.0100 | 0.0161 |

TABLE B3
In-sample Model Validation Results by Excluding Certain Features

| | Without UGC | Without Location | Without Service |
|---|---|---|---|
| (Hybrid Model) | Variables | Variables | Variables |
| RMSE | 0.0743 | 0.1159 | 0.1112 |
| MSE | 0.0055 | 00134 | 0.0124 |
| MAD | 0.0328 | 0.0360 | 0.0353 |

TABLE B4
In-sample Model Validation Results by Excluding Certain
UGC Features

| | Without | | | | |
|---|---|---|---|---|---|
| | All | | | Without | Without |
| (Hybrid | Text | Without | Without | Numeric | Reviewer |
| Model) | Features | Readability | Subjectivity | Rating | Identity |
| RMSE | 0.0678 | 0.0642 | 0.0539 | 0.0513 | 0.0435 |
| MSE | 0.0046 | 0.0041 | 0.0029 | 0.0026 | 0.0019 |
| MAD | 0.0309 | 0.0289 | 0.0201 | 0.0217 | 0.0156 |

TABLE B5
Out-of-sample Basic Model Validation Results

| | | BLP without | BLP with | | |
|---|---|---|---|---|---|
| | | Random | Random | | Nested Logit |
| | | Coef. on | Coef. on | | (Random |
| | Hybrid | Travel | Travel | | Utility |
| | Model | Categories | Categories | PCM | Maximization) |
| RMSE | 0.0881 | 0.1011 | 0.0975 | 0.1909 | 0.2399 |
| MSE | 0.0078 | 0.0102 | 0.0095 | 0.0364 | 0.0576 |
| MAD | 0.0276 | 0.0362 | 0.0387 | 0.0524 | 0.1311 |

TABLE B6
Out-of-sample Extended Model Validation Results

| | Hybrid Model With | BLP With |
|---|---|---|
| | Interaction Effects | Interaction Effects |
| RMSE | 0.0865 | 0.0922 |
| MSE | 0.0075 | 0.0085 |
| MAD | 0.0253 | 0.0287 |

TABLE B7
Out-of-sample Model Validation Results by Excluding Certain Features

| | Without UGC | Without Location | Without Service |
|---|---|---|---|
| (Hybrid Model) | Variables | Variables | Variables |
| RMSE | 0.1380 | 0.1992 | 0.1897 |
| MSE | 0.0190 | 0.0397 | 0.0360 |
| MAD | 0.0965 | 0.1276 | 0.1155 |

TABLE B8
Out-of-sample Model Validation Results by Excluding
Certain UGC Features

| | Without | | | Without | Without |
|---|---|---|---|---|---|
| (Hybrid | All Text | Without | Without | Numberic | Reviewer |
| Model) | Features | Readability | Subjectivity | Rating | Identity |
| RMSE | 0.1359 | 0.1252 | 0.1176 | 0.1116 | 0.0964 |
| MSE | 0.0185 | 0.0157 | 0.0138 | 0.0125 | 0.0093 |
| MAD | 0.0812 | 0.0618 | 0.0607 | 0.0583 | 0.0303 |

With respect to out-of-sample root mean square deviation (“RMSE”), the model fit can improve by 36.16% when adding the UGC variables. Similar trends in improvement in the exemplary embodiment model fit occur with respect to the other two metrics, mean squared error (“MSE”) and median absolute deviation (“MAD”), in both in-sample and out-of-sample analyses. The out-of-sample results in Table B5 illustrate that the above described exemplary model according to an exemplary embodiment of the present disclosure can improve by 12.86% in RMSE compared to the BLP model with no random coefficients on travel-category dummy variables. This number can become 53.85%, 63.28%, and 9.64% for the PCM, the Nested Logit model, and the BLP model with random coefficients on travel-category dummy variables, respectively.

Thus, the exemplary model according to certain exemplary embodiments of the present disclosure can provide the best overall performance in both precision (i.e., RMSE, MSE) and deviation (i.e., MAD) of the predicted market share. Moreover, as illustrated in Table B6, when incorporating interaction effects, although both models can show improvement in predictive power, the exemplary extended hybrid model can perform much better than the extended BLP model.

Table B7 illustrates that by including the UGC, location-based, and service-based variables, the exemplary hybrid model fit improves by 36.16%, 55.77%, and 53.56%, respectively, in RMSE. Similar trends in improvement in model fit can occur with respect to MSE and MAD. Therefore, the exemplary results can indicate that the model's predictive power would decrease the most if we were to exclude the location-based variables from the exemplary models, followed by the service-based variables, and finally followed by the UGC variables. This exemplary finding can strongly indicate that location- and service-based characteristics are indeed the two most influential factors for hotel demand. Moreover, Table B8 shows that of all the UGC-related features, e.g., textual information can improve the model's predictive power significantly more than the numerical features about 35.17% and 21.06%, respectively, in RMSE. In addition, within the set of textual features, the review readability and subjectivity can indicate a higher impact than the reviewer-identity information.

Table 2 shows the exemplary estimation results for the exemplary extended model with additional text features. The table shows that the qualitative nature of the other results remains the same. The three features that can have a positive and statistically significant impact on demand are food quality, hotel staff, and parking facilities. Amongst these exemplary features, food quality can present the highest positive impact, followed by hotel staff and parking. In contrast, a bedroom quality can show a negative impact on demand. This negative sign may be counterintuitive. One possible explanation is that consumers may use bedroom quality as a cue for price, especially when quality is used as a proxy for the number of beds and size of the room (e.g., full, queen, king, etc.). This situation can occur when prices are obfuscated on the main results page and are only available just before checkout.

TABLE 2
Extended Model (I)-With Additional Text Features

| | | | |
|---|---|---|---|
| Variable | Coef. (Std. Err)^{I} | Coef. (Std. Err)^{II} | Coef. (Std. Err)^{III} |

Means

| | | | |
|---|---|---|---|
| Price^{(L)} | −.144*** (.015) | −.150*** (.014) | −.157*** (.014) |
| CHARACTERS^{(L)} | .008*** (.001) | .009*** (.002) | .009*** (.002) |
| COMPLEXITY | −.015*** (.003) | −.014*** (.002) | −.012*** (.002) |
| SYLLABLES^{(L)} | −.043*** (.012) | −.044*** (.012) | −.045*** (.012) |
| SMOG | .081** (.029) | .078** (.027) | .076** (.029) |
| SPELLERR^{(L)} | −.132*** (.031) | −.132*** (.026) | −.139*** (.023) |
| SUB | −.149*** (.032) | −.151*** (.036) | −.162*** (.039) |
| SUBDEV | −.408*** (.100) | −.412*** (.095) | −.417*** (.102) |
| ID | .055* (.031) | .063* (.034) | .066* (.034) |
| CLASS | .039*** (.009) | .040*** (.009) | .045*** (.009) |
| CRIME | −.033** (.012) | −.032* (.017) | −.028* (.015) |
| EXTAMENITY^{(L)} | .008*** (.002) | .007*** (.001) | .007*** (.002) |
| BEACH | .157*** (.004) | .165*** (.004) | .163*** (.004) |
| LAKE | −.118*** (.030) | −.111*** (.031) | −.112*** (.033) |
| TRANS | .163*** (.003) | .167*** (.006) | .173*** (.009) |
| HIGHWAY | .065* (.028) | .070*** (.021) | .073** (.024) |
| DOWNTOWN | .044*** (.004) | .047*** (.004) | .048*** (.005) |
| TA RATING | .034* (.018) | .041** (.018) | .044** (.021) |
| TL RATING | .036*** (.005) | .037*** (.005) | .038*** (.006) |
| TA | .177*** (.038) | .180*** (.042) | .183*** (.043) |
| REVIEWCNT^{(L)} | | | |
| TA | −.059*** (.006) | −.063*** (.010) | −.062*** (.009) |
| REVIEWCNT\hat{ }2^{(L)} | | | |
| TL | .017*** (.002) | .016*** (.002) | .018*** (.002) |
| REVIEWCNT^{(L)} | | | |
| TL | −.025*** (.006) | −.031*** (.008) | −.032*** (.008) |
| REVIEWCNT\hat{ }2^{(L)} | | | |
| FOOD | .115** (.045) | .122*** (.034) | .124** (.042) |
| STAFF | .059** (.024) | .059** (.020) | .064** (.024) |
| BATHROOM | .046 (.103) | .047 (.105) | .045 (.110) |
| BEDROOM | −.015* (.007) | −.016 (.009) | −.016 (.011) |
| PARKING | .036*** (.007) | .037*** (.007) | .040*** (.009) |
| Constant | .031 (.019) | .032 (.022) | .035 (.026) |
| Brand Control | Yes | Yes | Yes |

Interaction Effect (αₗ) & Standard Deviations (αᵥ)

| | | | |
|---|---|---|---|
| Price^{(L)} × | .020*** (.004) | .026*** (.005) | .022*** (.007) |
| Income^{(L)} | | | |
| Price^{(L)} | .016 (.087) | .012 (.092) | .013 (.106) |

Standard Deviations (βᵥ)

| | | | |
|---|---|---|---|
| CLASS | .025*** (.006) | .031** (.011) | .033** (.012) |
| CRIME^{(L)} | .013 (.022) | .015 (.026) | .016 (.022) |
| AMENITYCNT^{(L)} | .024 (.037) | .023 (.035) | .029 (.043) |
| EXTAMENITY^{(L)} | .007 (.023) | .012 (.033) | .012 (.029) |
| BEACH | .065*** (.015) | .063*** (017) | .056** (.021) |
| LAKE | .114** (.044) | .103** (.041) | .099** (.038) |
| TRANS | .132* (.078) | .133* (.083) | .134* (.081) |
| HIGHWAY | .077* (.043) | .065 (.049) | .067 (.048) |
| DOTIWTOWN | .036*** (.009) | .039*** (.011) | .044*** (.014) |
| GMM Obj Value | 8.412e−4 | 8.066e−4 | 8.137e−4 |

***P <= 0.001
**P <= 0.01
*P <= 0.05
†P <= 0.1
^{I}Based on the main dataset (at least 1 review from either TA or TL).
^{II}Based on main dataset with reviews >= 5.
^{III}Based on main dataset with reviews >= 10.
^{(L)}Logarithm of the variable.

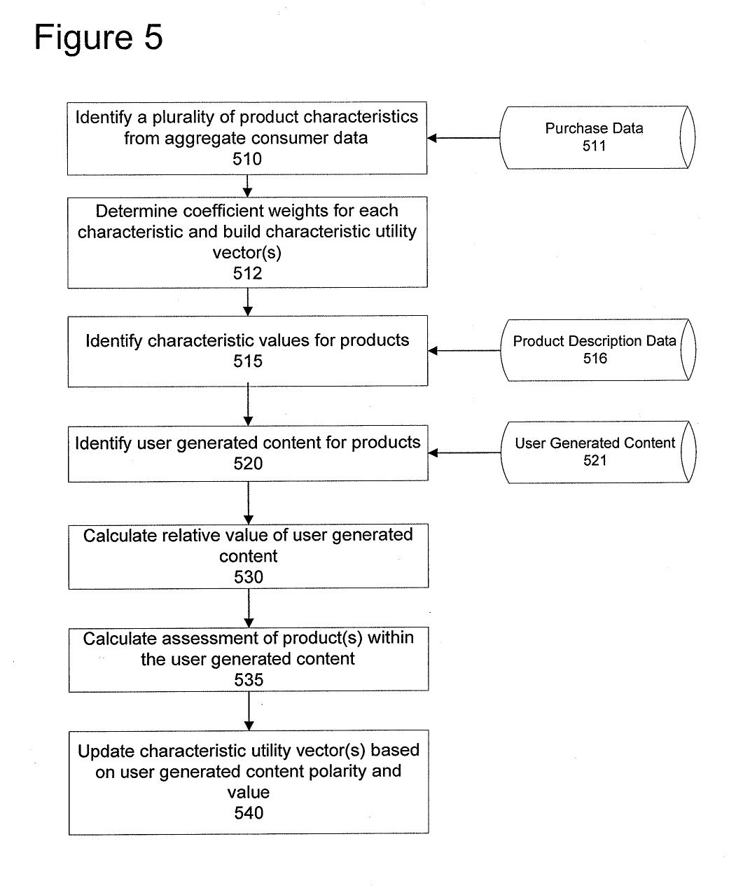

FIG. 5 illustrates a flow diagram of an exemplary method for building/generating characteristic coefficients for user-generated content, along with other sources of characteristic information according to another exemplary embodiment of the present disclosure. At procedure 510, the exemplary method can identify a plurality of product characteristics from aggregate consumer data 511. This aggregate consumer data 511 can be historical data, such as transactions from a large plurality of customers (e.g., all transaction data from an online booking site over the course of one or more years). Such data can be used, e.g., at procedure 512, to determine coefficient weights for each characteristic, and build characteristic utility vector(s) and/or matrices. These can be based on exemplary models discussed above, in determining how much relative value a consumer puts on each of the various characteristics.

For example, when the vector(s) of coefficients are built/generated, they can be applied to present and/or future product offerings, e.g., at procedure 515. Here, product description data 516 can be accessed to identify what each product offers for each characteristic (e.g., “no pool,” “outdoor pool,” “heated pool,” “indoor pool,” “lap pool,” “hot tub,” etc.). For objective data, such as, e.g., official certifications, amenity offerings, physical locations, etc., the data can be pulled from various factual sites (e.g., map programs, hotel classification lists, etc.) In addition, at procedure 520, the exemplary method can identify user-generated content about the products, e.g., from review sites, etc. This user-generated content can be automatically and/or manually parsed for relative value (e.g., as discussed above). In addition to weighting the value of the content (e.g., review), the content's assessment of the subject product can be determined, and that value-weighted assessment can be incorporated into the subject products characteristic utility vector(s). These vector(s) values can be used to form a general utility value for the subject property, which in turn can be used to order multiple products by relative surplus, as described in other exemplary embodiments of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A non-transitory computer-readable medium for providing results associated with a ranking of a plurality of items of a particular item type, including instructions thereon that are accessible by a hardware processing arrangement, wherein, when the processing arrangement executes the instructions, the processing arrangement is configured to perform procedures comprising:
for each respective item of a plurality of items having an associated cost:
determining an item utility value for a respective item of the items based on aggregate data associated with a plurality of users without requiring utilization of information particular to each of the users, and
determining a surplus value for the respective item as the item utility value less a cost utility value associated with the cost of the respective item; and
providing the results, based on the respective surplus values, to a particular user of the users.

2. The computer-readable medium of claim 1, wherein the providing procedure includes providing a list of products or services sorted or ranked based on the respective surplus values.

3. The computer-readable medium of claim 1, wherein the results include particular items representing a best value for a particular one of consumers or group of the consumers and the particular one of the items which differ from a list of best selling one of the items.

4. The computer-readable medium of claim 1, wherein each of the items includes a plurality of characteristics, each of the characteristics having a particular value for the particular one of the items, and having a weight, and the determination procedure includes summing weighted utility values for each of the characteristics of the respective item.

5. The computer-readable medium of claim 4, wherein the weight for each of the characteristics is determined based exclusively on anonymous data, and results are provided to the particular user without accounting for information specific to the particular user.

6. The computer-readable medium of claim 4, wherein the processing arrangement is further configured to perform procedures comprising:
receiving demographic data of the particular user; and
modifying the weight for a plurality of characteristic categories to reflect demographic data of the particular user.

7. The computer-readable medium of claim 4, wherein the processing arrangement is further configured to perform procedures comprising:
receiving financial data for the particular user; and
modifying the cost utility value based on the financial data of the particular user.

8. The computer-readable medium of claim 4, wherein the weights are based on market share data.

9. The computer-readable medium of claim 1, wherein the processing arrangement is further configured to perform procedures comprising:
receiving consumer demographic information for a plurality of consumers;
receiving demand data for the items; and
selecting particular ones of the items based on the consumer demographic information and demand data.

10. The computer-readable medium of claim 9, wherein the selected particular one of the items comprise a personalized surplus-based ranking of the items.

11. The computer-readable medium of claim 10, wherein the processing arrangement is further configured to perform procedures comprising inferring preferences of consumers for different item characteristics from the demand data for the items.

12. A non-transitory computer-readable medium for ranking a plurality of items of particular item types, including instructions thereon that are accessible by a hardware processing arrangement, wherein, when the processing arrangement executes the instructions, the processing arrangement is configured to perform procedures comprising:
identifying a plurality of characteristic categories for the particular item types;
identifying an importance weight for each of the characteristic categories;
determining a utility value for each of the items by:
determining a plurality of characteristic values for each of the items by measuring each of the characteristic categories for each of the items to determine the characteristic values for each of the items,
weighting each of the characteristic values according to a determined weight associated with an associated one of the characteristic categories, and
summing the weighted characteristic values into the utility value for each of the items;
determining a surplus value for each of the items as the utility value minus a cost utility value determined based at least in part on a price associated with each of the items; and
providing results based on the respective surplus values.

13. A computer implemented method for providing results associated with a ranking of a plurality of items of a particular item type, comprising:
for each respective item of a plurality of items having an associated cost:
determining, with a hardware processing arrangement, an item utility value for a respective item of the items based on aggregate data associated with a plurality of users without requiring utilization of information particular to each of the users;
determining a surplus value for the respective item as the item utility value less a cost utility value associated with the cost of the respective item; and
providing the results, based on the respective surplus values, to a particular user of the users.

14. The method of claim 13, wherein the providing procedure includes providing a list of products or services sorted or ranked based on the respective surplus values.

15. The method of claim 13, wherein the results include particular items representing a best value for a particular one of consumers or group of the consumers and the particular one of the items which differ from a list of best selling one of the items.

16. The method of claim 13, wherein each of the items includes a plurality of characteristics, each of the characteristics having a particular value for the particular one of the items, and having a weight, and the determination procedure includes summing weighted utility values for each of the characteristics of the respective item.

17. The method of claim 16, wherein the weight for each of the characteristics is determined based exclusively on anonymous data, and results are provided to the particular user without accounting for information specific to the particular user.

18. The method of claim 16, further comprising:
receiving demographic data of the particular user; and
modifying the weight for a plurality of characteristic categories to reflect demographic data of the particular user.

19. The method of claim 16, further comprising:
receiving financial data for the particular user; and
modifying the cost utility value based on the financial data of the particular user.

20. A system for providing results associated with a ranking of a plurality of items, comprising:
a hardware processing arrangement, configured to:
for each respective item of a plurality of items having an associated cost:
determine an item utility value for a respective item of the items based on aggregate data associated with a plurality of users without requiring utilization of information particular to each of the users, and
determine a surplus value for the respective item as the item utility value less a cost utility value associated with the cost of the respective item; and
provide the results, based on the respective surplus values, to a particular user of the users.
